(19) United States
(12) Patent Application Publication
(10) Pub. No.: US 2018/0196819 A1
(43) Pub. Date: Jul. 12, 2018

(54) SYSTEMS AND APPARATUSES FOR PROVIDING AN AUGMENTED REALITY REAL ESTATE PROPERTY INTERFACE

(71) Applicant: Move, Inc., Westlake Village, CA (US)

(72) Inventors: Fenjun ZHANG, Westlake Village, CA (US); Adam BOWRON, Westlake Village, CA (US); Lauren KAHN, Westlake Village, CA (US); Scott RUTHERFORD, Westlake Village, CA (US)

(21) Appl. No.: 15/870,471

(22) Filed: Jan. 12, 2018

Related U.S. Application Data
(60) Provisional application No. 62/445,575, filed on Jan. 12, 2017.

(51) Int. Cl. G06F 17/30; G06Q 50/16; G06T 7/70; G06T 7/80; G06T 19/00; H04W 4/02

(52) U.S. Cl. CPC G06F 17/3087; G06F 17/30268; G06Q 50/16; H04W 4/025; G06T 7/80; G06T 19/006; G06T 7/70

(57) ABSTRACT

Apparatuses, methods, and systems disclosed herein that utilizes environmental data captured by user devices in real-time to identify real estate property information. The real estate property information, corresponding to properties found in the environment, may be augmented within the real-time image of the environment allowing a viewer to quickly assess information about such properties. In one example embodiment, a method is provided comprising accessing a camera of a device and causing to display at least one image of an environment, the environment having at least one property, determining information associated with the at least one property, providing an informational identifier comprising at least a portion of the information associated with the at least one property via a user interface of the device; and causing to overlay the informational identifier so as to augment the at least one image of the environment shown on the user interface with the informational identifier.

### CROSS REFERENCE TO RELATED APPLICATIONS

This application claims the benefit of U.S. Provisional Patent Application No. 62/445,575 filed on Jan. 12, 2017, the entire contents of which are incorporated herein by reference.

### TECHNOLOGICAL FIELD

The present invention relates to searching and presenting real estate data, and more specifically, to providing and positioning augmented reality content associated with real estate property information to a viewer as if the content was part of the real world environment.

### BACKGROUND

The process of searching for a new home or renting an apartment is a major undertaking for a potential home buyer or renter and often includes repetitive, boring browsing at hundreds of property listings and organizing potential properties. Another major consideration is researching neighborhoods before relocating. Potential home buyers will often visit neighborhoods and drive around looking for available homes. If a buyer is out exploring a neighborhood and sees a property that interests the buyer, it may be difficult for the buyer to obtain and review information about the property. Conventional systems, which include websites configured to either (1) present a list of properties that are ranked and presented in some order unknown to a user, often without the input of user-specific criteria; or (2) overlay some indications of potential listings on a map, which requires heavy bandwidth and data usage on a mobile device. Once a listing is selected, conventional systems simply provide some pictures and a block paragraph of industry specific terms, which to a lay person, may be meaningless.

Augmented reality technology provides useful information as virtual content in conjunction with or overlaid on top of a photo or video captured scenery of the real world. Utilizing the various sensors that are now standard with mobile devices, for example, a GPS location as well as an orientation of the device, in conjunction with augmented reality technology, a potential home buyer may be presented with virtual content labels overlaying a captured scene of real-world objects such as a real estate property via their mobile device. These virtual content labels provide for the potential home buyer additional information related to the property. The user may also be provided with the ability to share his or her augmented reality view with friends and family members.

As described in detail below, the inventors have developed a versatile mobile application for meeting the above needs as well as enhancing and augmenting a user's vision and perception of a real estate property or any real-world object. Accordingly, the mobile application may use the camera features and/or sensors of a mobile phone or tablet to capture environmental data including but not limited to live video of the real-world location as captured by the mobile phone or tablet. In one embodiment, the environmental data is utilized to identify real estate property information. The real estate property information, corresponding to properties found in the environment, may be augmented within the real image of the environment allowing a viewer to quickly assess information about such properties the viewer sees in real-time. Although one or more examples are provided herein relating to exploring neighborhoods and identifying available homes, these are example use cases. Many variations are possible without departing from the spirit of the invention. For instance, other uses cases other than the example provided herein may include users potentially looking to: relocate to a new area, purchase a home, rent a home, sell a home, and/or invest in a home or property, locate a service or institution, identify a home builder, locate a good school system, etc.

As an example, one primary factor in home relocation is often close proximity of the potential home to a good quality school. A user may desire to know more about a school belonging to the neighborhood they are viewing. For example, when the field of view of the camera of the user's mobile device is pointed at and/or in the direction of the school, certain embodiments of the mobile application on the user's mobile device may provide to the user the school's information or statistics such as school name, school-level characteristics, size, popularity, test scores, programs and/or services offered, etc.

### BRIEF SUMMARY

Apparatuses, methods, and systems disclosed herein improve the process of searching for a property and presenting more information about that property in real-time. Fundamentally, example embodiments described herein rely on the fact that users of mobile devices equipped with cameras has become a ubiquitous feature of society. Accordingly, example embodiments facilitate a convenient and quick way to obtain property listing information that a user is physically looking at while exploring the neighborhood of that property.

In example embodiments, various methods, apparatuses, and systems are provided that facilitate improved query, retrieval, and display of property listing information. For example, example embodiments involve, accessing a camera of a device and causing to display at least one image of an environment, the environment having at least one property, determining information associated with the at least one property, providing an informational identifier comprising at least a portion of the information associated with the at least one property via a user interface of the device; and causing to overlay the informational identifier so as to augment the at least one image of the environment shown on the user interface with the informational identifier.

Although described using an example method above, an apparatus is also contemplated herein associated with the device. The apparatus includes at least one processor and at least one memory comprising instructions that when executed by a processor, cause the apparatus to access, from a camera of the device, and cause to display at least one image of an environment, the environment having at least one property, determine information associated with the at least one property, provide an informational identifier comprising at least a portion of the information associated with the at least one property via a user interface of the device; and cause to overlay the informational identifier so as to augment the at least one image of the environment shown on the user interface with the informational identifier.

Similarly, an example computer program product is also contemplated herein. The computer program product includes a non-transitory computer readable storage medium comprising instructions that, when executed by a device, configure the device to access, from a camera of the device, and cause to display at least one image of an environment, the environment having at least one property, determine information associated with the at least one property, provide an informational identifier comprising at least a portion of the information associated with the at least one property via a user interface of the device; and cause to overlay the informational identifier so as to augment the at least one image of the environment shown on the user interface with the informational identifier.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a schematic representation of a system that may support example embodiments of the present invention;

FIG. 2 is a block diagram of an electronic device that may be configured to implement example embodiments of the present invention;

FIG. 3 is a block diagram of an mobile device that may be embodied by or associated with an electronic device, and may be configured to implement example embodiments of the present invention;

FIG. 4 is a flowchart illustrating operations performed by a device in accordance with example embodiments of the present invention;

FIGS. 5A, 5B, 6, and 7 are schematic representations of user interfaces which may be displayed in accordance with example embodiments of the present invention.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., one or more volatile or non-volatile memory device), can be differentiated from a “computer-readable transmission medium,” which refers to an electromagnetic signal.

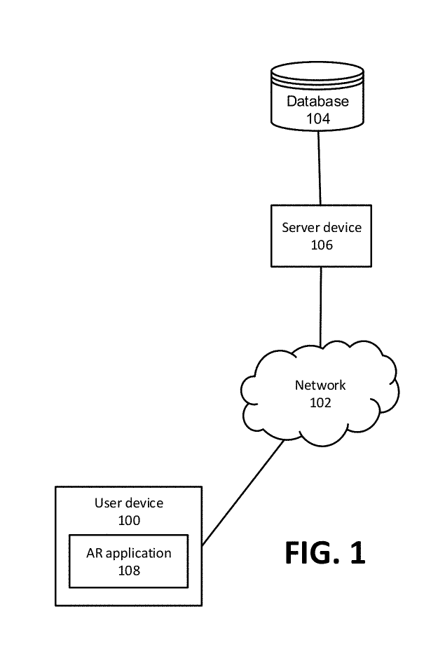

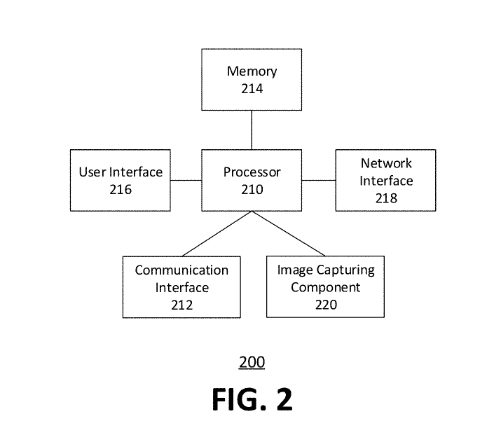

Reference is now made to FIG. 1 which illustrates a device 100 connected to a network 102. FIG. 1 also illustrates that in some embodiments, a server device 106 may also be connected to the network 102. The device 100 may be configured to communicate over any type of network. For example, the device 100 may be a mobile terminal, such as a mobile telephone, PDA, pager, laptop computer, tablet computer, smart phone, or any of numerous other hand held or portable communication devices, computation devices, content generation devices, content consumption devices, or combinations thereof. In accordance with some embodiments, the device 100 may include or be associated with an apparatus 200, such as that shown in FIG. 2 and described below.

In some embodiments, server device 106 may be further configured for creating the augmented reality. For example, as described in more detail below, user device 100 may capture the environment associated with the user device. The user device 100 may then transmit location information, camera data, and/or sensor data (i.e., magnetic field, accelerometer, rotation vector, and the like) to server device 106 which then the server device 106 integrates this information to provide a visually intuitive augmented reality arrangement and display of information associated with properties contained in the environment on a display of user device 100. User device 100 includes an AR application 108. The AR application 108 may utilize hardware functionality of the user device 100 including camera, global positioning satellite (GPS), compass, accelerometer, and/or gyroscope so as to provide a fluid, dynamic, and responsive user experience. The AR application 108 may provide tools to allow users to alter, move, or remove augmented reality content from the display of the user device 100. In some embodiments, the AR application 108 queries the server 106 for information about properties near the location of the user device 100. The server device 106 receives the request from the AR application 108 and in turn, sends information about the properties to the AR application 108 running on the user device 100. Accordingly, the AR application 108 provides an informational identifier comprising the information about the properties to be displayed on the user device 100. In some example embodiments, the informational identifier can be saved on the user device 100 to be later retrieved and or be sent or shared to others.

As shown in FIG. 1, device 100 may communicate with the server device 106 via network 102. Network 102 may be a wireless network, such as a Long Term Evolution (LTE) network, an LTE-Advanced (LTE-A) network, a Global Systems for Mobile communications (GSM) network, a Code Division Multiple Access (CDMA) network, e.g., a Wideband CDMA (WCDMA) network, a CDMA2000 network or the like, a General Packet Radio Service (GPRS) network, Wi-Fi, HSPA (High Speed Packet Access), HSPA+ (High Speed Packet Access plus) network, or other type of network.

Contained within database 104 are property listing data which may be any data and/or information relating to directly or indirectly to a real estate property. A real estate property, such as a home (e.g., single-family house, duplex, apartment, condominium, etc.), a commercial property, an industrial property, a multi-unit property, etc. Real estate data may include, but is not limited to, textual descriptions of the property, property price, property layout, property size, the street address of the property, the selling history of the property, data relating to neighboring sold properties, textual remarks relating to the property, data contained on a property condition form, audio comments relating to the property, inspection reports of the property, surveys and/or site maps of the property, photographs of various portions of the property, a video and/or virtual tour of the property, a video and/or virtual tour of the neighborhood, a video and/or virtual walk-through of the property, a video and/or virtual walk-through of the neighborhood, etc. Property data may also include data regarding whether the property is for sale. Such information is associated with a real estate listing service such as a Multiple Listing Service (MLS) information.

Because database 104 stores detailed information associated with a plurality of real estate properties, when a device initiates a property search request via the app, the device can query database 104 for property listing information and possibly other related information associated with the property listing. Property listing information may be provided directly to the device in response to provision of location, orientation, camera capture information, and sensor/module data of the device gathered from the device. AR application 108 may utilize the following information from device 100: image data captured by the camera, current location information provided by the GPS module, direction and position of the device 100 provided by the compass module, and rotation and drift information related to the device 100 provided by the accelerometer and gyroscope modules. The device may receive property listing information associated with the location data and cause to display the property listing information on the device. In causing to display the property listing information, the AR application is configured to determine the position and orientation of the device 100 relative to the real-world scene in an AR overlay so as to be visually compatible with objects within the real-world scene, or to effectively convey related position/orientation information.

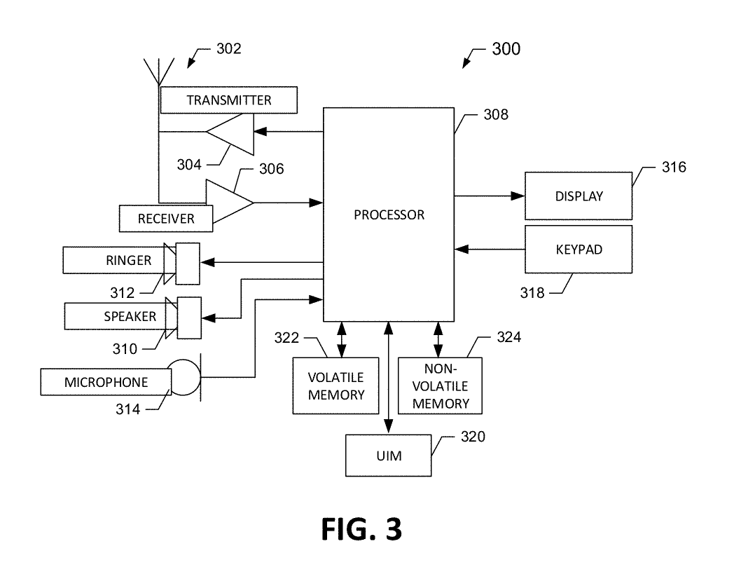

Referring now to FIG. 2, an apparatus 200 is illustrated that may comprise device 100 and/or server device 106. Apparatus 200 includes constituent components including, but not necessarily limited to, a processor 210, a communication interface 212, a memory 214, and a user interface 216. In some embodiments, the processor 210 (and/or co-processors or any other processing circuitry assisting or otherwise associated with the processor 210) may be in communication with memory 214. The memory 214 may include, for example, one or more volatile and/or non-volatile memories. In other words, for example, the memory 214 may be an electronic storage device (e.g., a computer readable storage medium) comprising gates configured to store data (e.g., bits) that may be retrievable by a machine (e.g., a computing device like the processor 210). In some embodiments, the memory 214 may have constituent elements 322 and 324, which are referenced below in connection with FIG. 3. The memory 214 may be configured to store information, data, content, applications, instructions, or the like, for enabling the apparatus to carry out various functions in accordance with an example embodiment of the present invention. For example, the memory 214 could be configured to buffer input data for processing by the processor 210. Additionally or alternatively, the memory 214 could be configured to store instructions for execution by the processor 210. Specifically, the memory 214 may have stored thereon a snap property sign application (or “app”) that, upon execution, configures the apparatus 200 to provide the functionality described herein.

The apparatus 200 may, in some embodiments, be embodied by or associated with a mobile terminal (e.g., mobile terminal 300, which is described in greater detail below in connection with FIG. 3). In these or other embodiments, the apparatus 200 may be embodied as a chip or chip set. In other words, the apparatus 200 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 200 may therefore, in some cases, be configured to implement an embodiment of the present invention on a single chip or as a single “system on a chip.” As such, in some cases, a chip or chipset may constitute means for performing one or more operations for providing the functionalities described herein.

The processor 210 may be embodied in a number of different ways. For example, the processor 210 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 50 may include one or more processing cores configured to perform independently. A multi-core processor may enable multiprocessing within a single physical package. Additionally or alternatively, the processor 210 may include one or more processors configured in tandem via a bus to enable independent execution of instructions, pipelining and/or multithreading. In embodiments in which the apparatus 200 is embodied as mobile terminal 300 shown in FIG. 3, the processor 210 may be embodied by the processor 308.

The processor 210 may be configured to execute instructions stored in the memory 214 or otherwise accessible to the processor 210. Alternatively or additionally, the processor 210 may be configured to execute hard coded functionality. As such, whether configured by hardware or software methods, or by a combination thereof, the processor 210 may represent an entity (e.g., physically embodied in circuitry) capable of performing operations described herein, and thus may be physically configured accordingly. Thus, for example, when the processor 210 is embodied as an ASIC, FPGA or the like, the processor 210 may include specifically configured hardware for conducting the operations described herein. Alternatively, as another example, when the processor 210 is embodied as an executor of software instructions, the instructions may specifically configure the processor 210 to perform the algorithms and/or operations described herein when the instructions are executed. For instance, when the processor 210 is a processor of a specific device (e.g., a mobile terminal or network entity) configured to embody the device contemplated herein (e.g., user device 100 or server device 106) that configuration of the processor 210 occurs by instructions for performing the algorithms and/or operations described herein. The processor 210 may include, among other things, a clock, an arithmetic logic unit (ALU) and logic gates configured to support operation of the processor 210.

Processor 210 may further control an image capturing component 220 comprising an optical and/or acoustical sensor, for instance a camera and/or a microphone. An optical sensor may for instance be an active pixel sensor (APS) and/or a charge-coupled device (CCD) sensor. The image capturing component 220 may be attached to or integrated in apparatus 200.

Meanwhile, the communication interface 212 may be any means such as a device or circuitry embodied in either hardware or a combination of hardware and software that is configured to receive and/or transmit data from/to a network, such as network 102, and/or any other device or module in communication with the apparatus 200. In this regard, the communication interface 212 may include, for example, an antenna (or multiple antennas) and supporting hardware and/or software for enabling communications with a wireless communication network. Additionally or alternatively, the communication interface 212 may include the circuitry for interacting with the antenna(s) to cause transmission of signals via the antenna(s) or to handle receipt of signals received via the antenna(s). In some environments, the communication interface 212 may alternatively or also support wired communication. As such, for example, the communication interface 212 may include a communication modem and/or other hardware/software for supporting communication via cable, digital subscriber line (DSL), universal serial bus (USB) or other mechanisms. For instance, when the apparatus 200 comprises a mobile terminal such as that shown in FIG. 3, the communication interface 212 may be embodied by the antenna 302, transmitter 304, receiver 306, or the like.

In some embodiments, such as instances in which the apparatus 200 is embodied by device 100, the apparatus 200 may include a user interface 216 that may, in turn, be in communication with the processor 210 to receive an indication of a user input and/or to cause provision of an audible, visual, mechanical or other output to the user. As such, the user interface 216 may include, for example, a keyboard, a mouse, a joystick, a display, a touch screen(s), touch areas, soft keys, a microphone, a speaker, or other input/output mechanisms. Alternatively or additionally, the processor 210 may comprise user interface circuitry configured to control at least some functions of one or more user interface elements such as, for example, a speaker, ringer, microphone, display, and/or the like. The processor 210 and/or user interface circuitry comprising the processor 210 may be configured to control one or more functions of one or more user interface elements through computer program instructions (e.g., software and/or firmware) stored on a memory accessible to the processor 210 (e.g., memory 214, and/or the like).

In some embodiments, device 100 may be embodied by mobile terminals. In this regard, a block diagram of an example of such a device is mobile terminal 300, illustrated in FIG. 3. It should be understood that the mobile terminal 300 is merely illustrative of one type of user device that may embody devices 100 and 104. As such, although numerous types of mobile terminals, such as PDAs, mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, may readily be used in some example embodiments, other user devices including fixed (non-mobile) electronic devices may be used in some other example embodiments.

The mobile terminal 300 may include an antenna 302 (or multiple antennas) in operable communication with a transmitter 304 and a receiver 306. The mobile terminal 300 may further include an apparatus, such as a processor 308 or other processing device (e.g., processor 50 of the apparatus of FIG. 3), which controls the provision of signals to, and the receipt of signals from, the transmitter 304 and receiver 306, respectively. The signals may include signaling information in accordance with the air interface standard of an applicable cellular system, and also user speech, received data and/or user generated data. In this regard, the mobile terminal 300 is capable of operating with one or more air interface standards, communication protocols, modulation types, and access types. By way of illustration, the mobile terminal 300 is capable of operating in accordance with wireless communication mechanisms. For example, mobile terminal 300 may be capable of communicating in a wireless local area network (WLAN) or other communication networks, for example in accordance with one or more of the IEEE 802.11 family of standards, such as 802.11a, b, g, or n. As an alternative (or additionally), the mobile terminal 300 may be capable of operating in accordance with any of a number of first, second, third and/or fourth-generation cellular communication protocols or the like. For example, the mobile terminal 300 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like.

In some embodiments, the processor 308 may include circuitry desirable for implementing audio and logic functions of the mobile terminal 300. For example, the processor 308 may be comprised of a digital signal processor device, a microprocessor device, and various analog to digital converters, digital to analog converters, and other support circuits. Control and signal processing functions of the mobile terminal 300 are allocated between these devices according to their respective capabilities. The processor 308 thus may also include the functionality to convolutionally encode and interleave message and data prior to modulation and transmission. The processor 308 may additionally include an internal voice coder, and may include an internal data modem. Further, the processor 308 may include functionality to operate one or more software programs, which may be stored in memory. For example, the processor 308 may be capable of operating a connectivity program, such as a conventional Web browser. The connectivity program may then allow the mobile terminal 300 to transmit and receive Web content, such as location-based content and/or other web page content, according to a Wireless Application Protocol (WAP), Hypertext Transfer Protocol (HTTP) and/or the like, for example.

The mobile terminal 300 may also comprise a user interface including an output device such as a conventional earphone or speaker 310, a ringer 312, a microphone 314, a display 316, and a user input interface, all of which are coupled to the processor 308. The user input interface, which allows the mobile terminal 300 to receive data, may include any of a number of devices allowing the mobile terminal 300 to receive data, such as a keypad 318, a touch screen display (display 316 providing an example of such a touch screen display) or other input device. In embodiments including the keypad 318, the keypad 318 may include the conventional numeric (0-9) and related keys (#, *), and other hard and soft keys used for operating the mobile terminal 25. Alternatively or additionally, the keypad 318 may include a conventional QWERTY keypad arrangement. The keypad 318 may also include various soft keys with associated functions. In addition, or alternatively, the mobile terminal 300 may include an interface device such as a joystick or other user input interface. Some embodiments employing a touch screen display, as described further below, may omit the keypad 318 and any or all of the speaker 310, ringer 312, and microphone 314 entirely. The mobile terminal 300 further includes a battery, such as a vibrating battery pack, for powering various circuits that are required to operate the mobile terminal 300, as well as optionally providing mechanical vibration as a detectable output.

The mobile terminal 300 may further include a user identity module (UIM) 320. The UIM 320 is typically a memory device having a processor built in. The UIM 320 may include, for example, a subscriber identity module (SIM), a universal integrated circuit card (UICC), a universal subscriber identity module (USIM), a removable user identity module (R-UIM), etc. The UIM 320 typically stores information elements related to a mobile subscriber. In addition to the UIM 320, the mobile terminal 300 may be equipped with memory. For example, the mobile terminal 300 may include volatile memory 322, such as volatile Random Access Memory (RAM) including a cache area for the temporary storage of data. The mobile terminal 300 may also include other non-volatile memory 324, which may be embedded and/or may be removable. The memories may store any of a number of pieces of information, and data, used by the mobile terminal 200 to implement the functions of the mobile terminal 300.

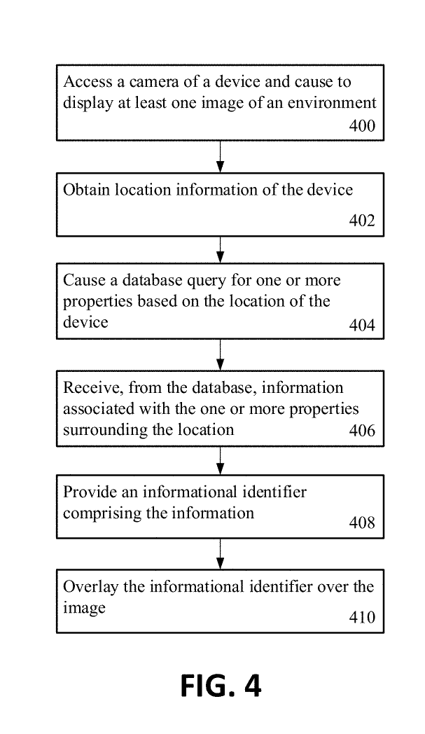

Thus, turning now to FIG. 4, the operations facilitating use of device 100 will now be described. One primary context in which the following operations may be useful is when a user new to a city is driving around checking out neighborhoods for real estate properties. In this regard and as described below, the operations of FIG. 4 may be performed by an apparatus 200, such as shown in FIG. 2, which may comprise a mobile station 300, as described in greater detail in FIG. 3. In this regard, the apparatus 200 may include means, such as a processor 210, memory 214, communication interface 212, and/or user interface 216 for executing operations described herein.

Returning to the specific operations of the device 100, the device 100 provides a series of possible procedures to the user. One of these procedures is to initiate a request for property listing information on one or more properties the user is currently viewing. In block 400, the app accesses a camera of the device 100 and causes to display at least one image of an environment of at which the device 100 is located. A portion of the environment may comprise, for example, a street of houses. Additionally, the image of the environment comprises data related to position, size, and angle information of the objects found the environment.

Using GPS and other sensors such as gyroscopes, accelerometers, tilt sensors, or electronic compasses, etc., the device 100 can automatically send the orientation and location of the user device 100 to be analyzed by the server device 106. The location information may include, but is not limited to, neighboring property names, street data, global positioning system (GPS) data, positioning systems data, and/or longitude and latitude data. The location information determination may include, but is not limited to, GPS, Assisted GPS, cell tower based location determination, Wi-Fi access points, or RFID based location determinations.

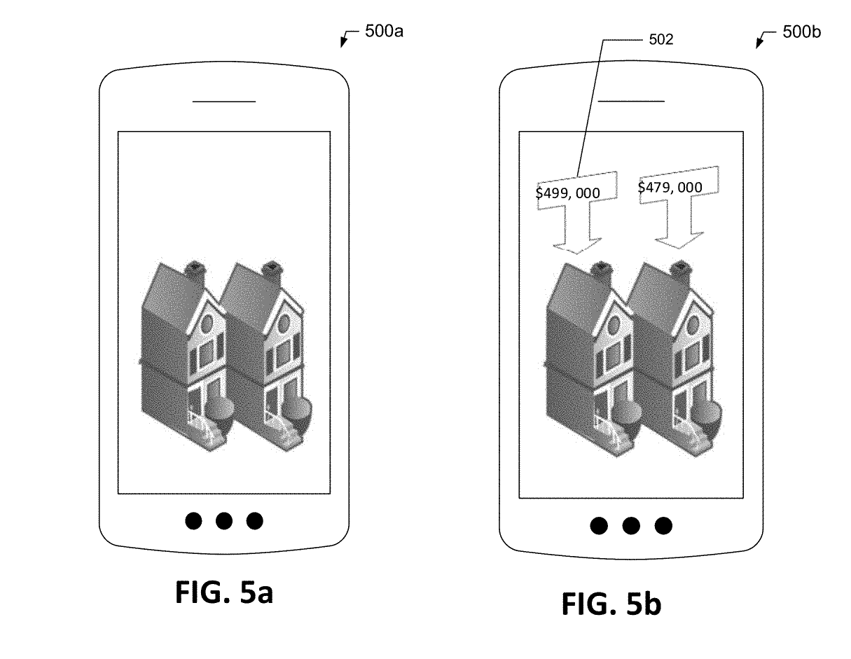

Once the location information of the device is obtained as shown in block 402, the apparatus 200 may cause a database query for one or more properties based on the location information as shown in block 404 which may return, from the database, property listing information associated with the one or more properties surrounding the location in accordance with block 406. This information causes the AR application to provide an informational identifier comprising at least a portion of the information associated with the one or more properties (block 408). The AR application may then calculate a subset of results from the received one or more properties surrounding the location which are in view with respect to an exact camera orientation. For example, when there are properties which are only partially in view, but are not fully visible according to the exact camera orientation, the app may show and apply informational identifiers to the properties in complete view with respect to the exact camera orientation as depicted in FIG. 5b. Accordingly, the informational identifier is overlaid on the display so as to augment the real-time image of the environment shown on the user interface with the informational identifier (block 410).

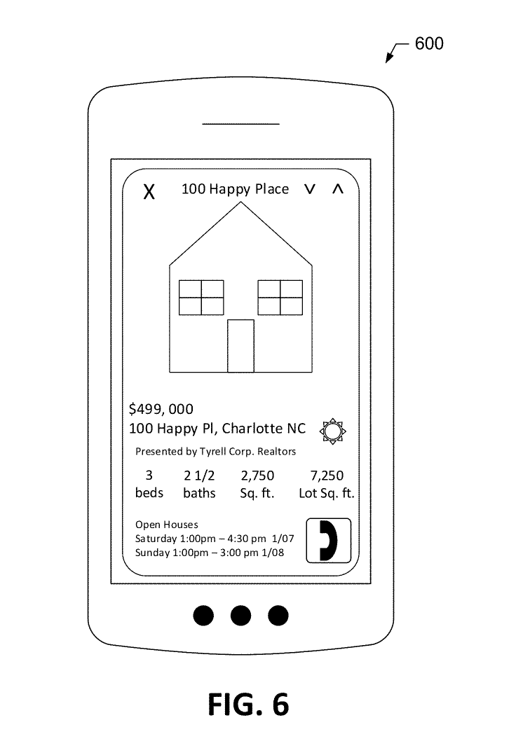

FIGS. 5a and 5b show example information screens that visually presents the real-time environment as captured by the user device 100 and the overlaid informational identifier 502 augmenting the environment shown on the screen. In another embodiment, when a user wishes to view more detailed information about a particular property, the user may provide input such as selection of a particular property in which more information about the selected property is displayed as shown in FIG. 6.

FIG. 6 shows an example information screen that visually presents the property listing information. The screen displays text and images of the property, property price, property layout, property size, street address of the property, open house schedule, and contact information.

In some embodiments of the user device, the AR application 108 determines a view of the camera of the device and applies an angle and position to overlay the informational identifier based on the determined view of the camera. For example, an approximate angle and/or position is calculated so that the informational identifier is positioned relative to its associated property as shown in FIG. 5b. The informational identifier 502 is positioned above the property with the property price. Further embodiments include sensing changes in orientation of the user device at which the device is held by the user and reconfiguring the informational identifier so as to be oriented in the same orientation as the current orientation of the device. Furthermore, as more metadata associated with the properties becomes available, placement and orientation of the informational identifier may become more precise with respect to altitude and/or latitude and longitude positioning.

The AR application 108 may also provide controls so as to allow the user to alter, move, or remove some or all informational identifiers on display. For example, certain controls allow for the user to request informational identifiers on all properties, not just those identified as for sale.

In another embodiment of the app, the app may allow the user to specify characteristics or attributes of the neighborhood or area shown on the device. For example, the user may desire a neighborhood having a good, quality school having specific test scores, or a neighborhood that is near a public transportation service, and so on. As such, the app provides information based on the desired characteristics or attributes of the neighborhood. Similar techniques may be provided for identifying properties, services, institutions, etc., that meet the characteristics or attributes specified by the user.

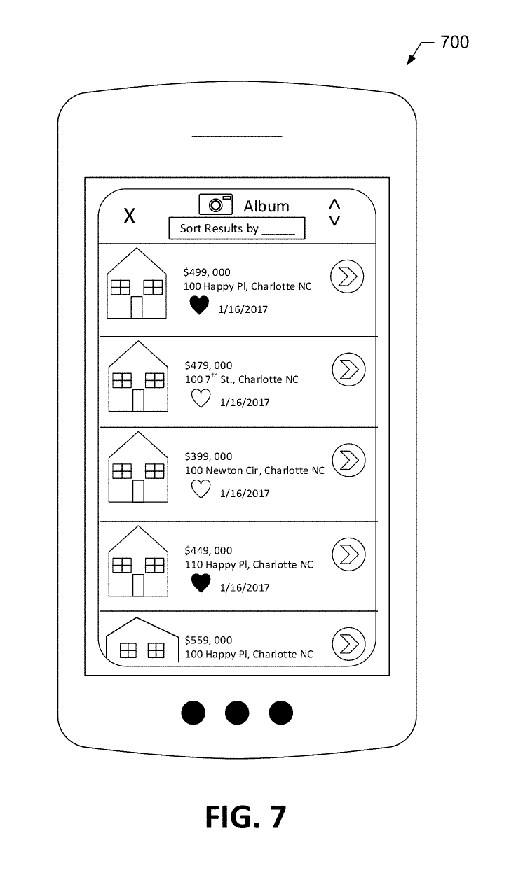

In some embodiments the device provides a type of photo repository for the captured images. In addition, shared access may be provided via a URL path allowing the user to share their augmented reality experience to others and/or social networks. Subsequently, the URL can be deconstructed to provide a list of the viewed properties, institutions, services, or objects by the user or another user, via the app or the realtor.com website. An example list of viewed properties is shown in FIG. 7. The app also enables the user to save, favorite, delete, sort, filter, change or update all photos and properties. Furthermore, the app provides a cached copy of the properties so as to streamline the user experience and reduce load and latency.

In accordance with a further embodiment, the app may also integrate with a virtual reality property tour simulating a user walking into the property. The images in the virtual may also be captured and stored by the app. Thus, a virtual tour in combination with the augmented reality content provided by the app provides the user a better understanding of the environment, neighborhood, or area surrounding the property and the property itself.

Certain embodiments of the app may deliver information to other applications executing on the device 100. For example, in one embodiment, the device 100 may automatically deliver open house schedules to the calendar module of the device.

As noted above, searching for a new home can be quite an undertaking for a potential home buyer and can become a monotonous task of browsing at hundreds of property listings. Certain embodiments of the app takes advantage of a user casually driving through a neighborhood searching for a home by utilizing the user's mobile camera to capture a real estate property sign and quickly retrieving property listing information.

It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or enhanced. Furthermore, in some embodiments, additional optional operations may be included. Modifications, additions, or enhancements to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
accessing a camera of a device and causing to display at least one image of an environment, the environment having one or more properties;
determining information associated with the one or more properties;
providing an informational identifier comprising at least a portion of the information associated with the one or more properties via a user interface of the device; and
causing to overlay the informational identifier so as to augment the at least one image of the environment shown on the user interface with the informational identifier.

2. The method of claim 1 further comprising:
obtaining location information of the device;
causing a database query for the one or more properties based on the location information of the device; and
receiving, from the database, the information associated with the one or more properties surrounding the location.

3. The method of claim 1, further comprising:
determining a view of the camera of the device; and
applying an angle and position to overlay the informational identifier based on the determined view of the camera.

4. The method of claim 1, further comprising:
sensing changes in orientation at which the device is held; and
reconfiguring the informational identifier oriented based on a current orientation of the device.

5. The method of claim 4, wherein the sensing changes in orientation at which the device is held comprises receiving a signal from at least one of: gyroscopes, accelerometers, tilt sensors, or electronic compasses.

6. The method of claim 1, further comprising:
receiving, from an input component of the device, a user instruction to alter, move, or remove the informational identifier shown on the user interface; and
causing to update the informational identifier based on the user instruction.

7. An apparatus comprising at least one processor and at least one memory, the memory comprising instructions that, when executed by a processor, configure the apparatus to:
access, from a camera of a device, and cause to display at least one image of an environment, the environment having one or more properties;
determine information associated with the one or more properties;
provide an informational identifier comprising at least a portion of the information associated with the one or more properties via a user interface of the device; and
cause to overlay the informational identifier so as to augment the at least one image of the environment shown the user interface with the informational identifier.

8. The apparatus of claim 7, wherein the apparatus is further configured to:
obtain location information of the device;
cause a database query for the one or more properties based on the location information of the device; and
receive, from the database, the information associated with the one or more properties surrounding the location.

9. The apparatus of claim 7, wherein the apparatus is further configured to:
determine a view of the camera of the device; and
apply an angle and position to overlay the informational identifier based on the determined view of the camera.

10. The apparatus of claim 7, wherein the apparatus is further configured to:
sense changes in orientation at which the device is held; and
reconfigure the informational identifier oriented based on a current orientation of the device.

11. The apparatus of claim 10, wherein the sensing changes in orientation at which the device is held comprises receiving a signal from at least one of: gyroscopes, accelerometers, tilt sensors, or electronic compasses.

12. The apparatus of claim 7, wherein the apparatus is further configured to:
receive, from an input component of the device, a user instruction to alter, move, or remove the informational identifier shown on the user interface; and
cause to update the informational identifier based on the user instruction.

13. A computer program product comprising a non-transitory computer readable storage medium, the non-transitory computer readable storage medium comprising instructions that, when executed by a device, configure the device to:
access, from a camera of a device, and cause to display at least one image of an environment, the environment having one or more properties;
determine information associated with the one or more properties;
provide an informational identifier comprising at least a portion of the information associated with the one or more properties via a user interface of the device; and
cause to overlay the informational identifier so as to augment the at least one image of the environment shown the user interface with the informational identifier.

14. The computer program product of claim 1, wherein the instructions further comprise instructions that, when executed by the device, are configured to:
obtain location information of the device;
cause a database query for the one or more properties based on the location information of the device; and
receive, from the database, the information associated with the one or more properties surrounding the location.

15. The computer program product of claim 1, wherein the instructions further comprise instructions that, when executed by the device, are configured to:
determine a view of the camera of the device; and
apply an angle and position to overlay the informational identifier based on the determined view of the camera.

16. The computer program product of claim 1, wherein the instructions further comprise instructions that, when executed by the device, are configured to:
sense changes in orientation at which the device is held; and
reconfigure the informational identifier oriented based on a current orientation of the device.

17. The computer program product of claim 4, wherein the sensing changes in orientation at which the device is held comprises receiving a signal from at least one of: gyroscopes, accelerometers, tilt sensors, or electronic compasses.

18. The computer program product of claim 1, wherein the instructions further comprise instructions that, when executed by the device, are configured to:
receive, from an input component of the device, a user instruction to alter, move, or remove the informational identifier shown on the user interface; and
cause to update the informational identifier based on the user instruction.
